(19) United States
(12) Patent Application Publication
(10) Pub. No.: US 2022/0343154 A1
(43) Pub. Date: Oct. 27, 2022

(54) METHOD, ELECTRONIC DEVICE, AND COMPUTER PROGRAM PRODUCT FOR DATA DISTILLATION

(71) Applicant: EMC IP Holding Company LLC, Hopkinton, MA (US)

(72) Inventors: Zijia Wang, WeiFang (CN); Jiacheng Ni, Shanghai (CN); Qiang Chen, Shanghai (CN); Zhen Jia, Shanghai (CN)

(21) Appl. No.: 17/318,568

(22) Filed: May 12, 2021

(30) Foreign Application Priority Data
Apr. 23, 2021 (CN) 202110442023.8

(51) Int. Cl. G06N 3/08; G06N 3/04

(52) U.S. Cl. CPC G06N 3/08; G06N 3/04

(57) ABSTRACT

Embodiments of the present disclosure relate to a method, an electronic device, and a computer program product for data distillation. The method includes: training an input data set by using a machine learning training process to establish a training model of the input data set; extracting multiple weights from the training model of the input data set, wherein the multiple weights contain information indicating the input data set, and the multiple weights are orthogonal to each other; and retraining the training model by using the multiple weights for generating a reconstructed data set. The embodiments of the present disclosure can greatly reduce the data storage cost of a data storage system and maintain the performance of the data storage system.

### RELATED APPLICATION(S)

The present application claims priority to Chinese Patent Application No. 202110442023.8, filed Apr. 23, 2021, and entitled “Method, Electronic Device, and Computer Program Product for Data Distillation,” which is incorporated by reference herein in its entirety.

### FIELD

Embodiments of the present disclosure generally relate to the field of data storage systems, and in particular, to a method, an electronic device, and a computer program product for data distillation of a data storage system.

### BACKGROUND

With the development of artificial intelligence technologies, various systems, including data storage systems, increasingly rely on large amounts of data and computing power to store and process tasks involving data. However, as data management tools, machine learning models and basic information technology systems are usually complex and expensive. In order to reduce the burden of processing massive data, a data distillation method has been proposed in recent years. The basic idea of data distillation is to distill or extract knowledge from a large training data set to form a smaller training data set, but still maintain main information of the original training data set.

In a data storage system, users often expect to store as much data as possible in a limited storage space. However, a traditional data distillation algorithm requires a lot of computing resources, and usually exhibits lows efficiency and low robustness when updating data samples.

### SUMMARY

Embodiments of the present disclosure provide a method, an electronic device, and a computer program product for data distillation of a data storage system.

In a first aspect of the present disclosure, a method for data distillation of a data storage system is provided. The method includes: training an input data set by using a machine learning training process to establish a training model of the input data set; extracting multiple weights from the training model of the input data set, wherein the multiple weights contain information indicating the input data set, and the multiple weights are orthogonal to each other; and retraining the training model by using the multiple weights for generating a reconstructed data set.

In a second aspect of the present disclosure, an electronic device is provided, including: at least one processing unit; and at least one memory coupled to the at least one processing unit and storing instructions for execution by the at least one processing unit, wherein the instructions, when executed by the at least one processing unit, cause the electronic device to perform actions including: training an input data set by using a machine learning training process to establish a training model of the input data set; extracting multiple weights from the training model of the input data set, wherein the multiple weights contain information indicating the input data set, and the multiple weights are orthogonal to each other; and retraining the training model by using the multiple weights for generating a reconstructed data set.

In a third aspect of the present disclosure, a computer program product is provided. The computer program product is tangibly stored in a non-transitory computer storage medium and includes machine-executable instructions. The machine-executable instructions, when executed by a device, cause this device to implement any step of the method described according to the first aspect of the present disclosure.

This Summary is provided to introduce the selection of concepts in a simplified form, which will be further described in the Detailed Description below. The Summary is neither intended to identify key features or necessary features of the present disclosure, nor intended to limit the scope of the present disclosure.

### BRIEF DESCRIPTION OF THE DRAWINGS

The above and other objectives, features, and advantages of the present disclosure will become more apparent by the following description of example embodiments of the present disclosure, to be viewed in combination with the accompanying drawings. In the example embodiments of the present disclosure, the same reference numerals generally represent the same parts.

FIG. 1 is a schematic diagram of an example environment in which an embodiment of the present disclosure can be implemented;

FIG. 2 is a flowchart of an example method for data distillation in a data storage system according to an embodiment of the present disclosure;

FIG. 3 is a schematic diagram of another example environment in which an embodiment of the present disclosure can be implemented;

FIG. 4 is a flowchart of an example method for retraining a training model according to extracted weights according to an embodiment of the present disclosure;

FIG. 5 is a schematic diagram of an example image generated by using the method of the present disclosure according to an embodiment of the present disclosure; and

FIG. 6 is a schematic block diagram of an example device that can be used to implement an embodiment of the present disclosure.

In the accompanying drawings, the same or corresponding numerals represent the same or corresponding parts.

### DETAILED DESCRIPTION

Illustrative embodiments of the present disclosure will be described in more detail below with reference to the accompanying drawings. While illustrative embodiments of the present disclosure are shown in the accompanying drawings, it should be understood that the present disclosure can be implemented in various forms without being limited to the embodiments set forth herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

The concept of data distillation or data set distillation is derived from improvement of data compression or deep learning models. For example, a deep supervised learning model requires a lot of data, and this often means training with a very large number of samples. In order to reduce the number of samples needed for training, and at the same time to affect the performance of the training model as little as possible, a data distillation algorithm or solution is proposed. Humans seem to be able to quickly summarize useful information from only a very small number of examples. For example, a painter can depict typical characteristics of a particular object or person with only a few strokes; a criminal investigator can also use a few words to describe the appearance of a person involved in a criminal case; and so do various other examples. Generally, it is expected that machines can have similar capabilities to learn from a small amount of data and summarize and extract the most useful information. A few-shot learning (FSL) method has been tried in this regard, wherein the model can be used to distinguish new categories in a case where only a few samples are given in each category. Furthermore, for the case where only one sample or even less than one sample is given for each category, a one-shot learning (OSL) method and a less than one-shot learning (LOSL) method have been proposed at present.

In an existing data set distillation solution, it is shown that the data set distillation (DD) may use a backward propagation algorithm to create a small synthetic data set, which compresses 60,000 modified National Institute of Standards and Technology (MNIST) training images into only 10 synthetic distillation images (one distillation image for each category), and achieves an accuracy of more than 90%. In another existing data set distillation solution, it is shown that the size of a data set may be further reduced by using learnable “soft” labels to enhance the data set distillation. This solution can create data sets of 5 distillation images for 10 categories. However, this type of data set distillation solution is limited by its assumptions on an original data model, that is, it assumes that the original data model is fixed, and therefore further assumes that a training network trained for the original data set is also fixed.

A solution for data distillation of a data storage system is provided in the embodiments of the present disclosure to solve the above problem and one or more of other potential problems. According to an embodiment of the present disclosure, a machine learning algorithm can be used to train an original data set, and a reconstructed data set may be generated according to weights extracted from a training model. A novel data distillation method is provided in the present disclosure to distill data. Different from previous knowledge distillation algorithms, the technical solution of the present disclosure is directly used to generate a new reconstructed data set, such as images and texts. In addition, a new training model framework or platform is further provided in the technical solution of the present disclosure, which can automatically extract features of the original data set and weights containing main information of the original data set for directly generating a new reconstructed data set, and can also deal with possible external disturbances or random noises, thereby effectively improving the robustness and stability of a self-supervised data distillation framework of a data storage system.

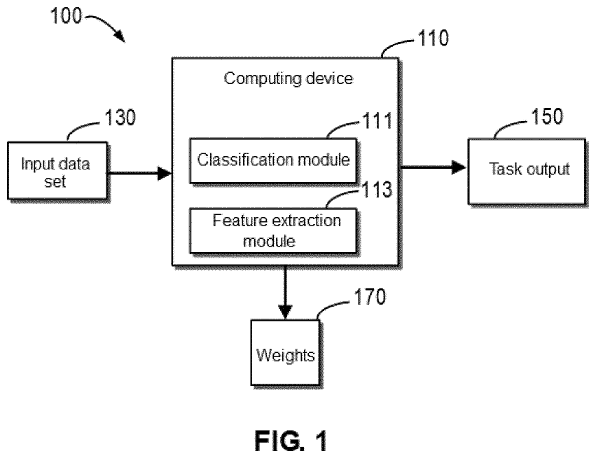

The embodiments of the present disclosure will be described in detail below with reference to FIG. 1 to FIG. 6. FIG. 1 is a block diagram of example environment 100 in which an embodiment of the present disclosure can be implemented. As shown in FIG. 1, environment 100 includes computing device 110, input data set 130, task output 150, and extracted weights 170. It should be understood that the structure of environment 100 is described only for illustrative purposes, and does not imply any limitation to the scope of the present disclosure. For example, the embodiments of the present disclosure may also be applied to an environment different from environment 100.

Computing device 110 may be, for example, any physical computer, virtual machine, server, or the like where a user application is run. It should be understood that computing device 110 may be included in a data storage system, or used as a plug-and-play plug-in outside the data storage system. For the purpose of example, FIG. 1 only depicts main components involved in operations such as training on input data set 130, which does not mean to limit the type of each component (for example, hardware or software) and an actual location of the component.

Computing device 110 may include classification module 111 and feature extraction module 113. It should be understood that computing device 110 may also include other types of modules for performing other types of operations on the input data set, such as sorting the input data set. According to an embodiment of the present disclosure, classification module 111 may be configured to classify input data set 130, for example, using a fully connected layer (FCL) process or the like. According to an embodiment of the present disclosure, feature extraction module 113 may be configured to perform feature extraction on input data set 130, for example, using a convolutional neural network (CNN) process or the like. It should be understood that classification module 111 and feature extraction module 113 may also use other machine learning processes or data compression processes to implement classification and feature extraction of the input data set. After computing device 110 calculates input data set 130, task output 150 and weights 170 can be obtained. Task output 150 is, for example, a small number of synthetic distillation images, synthetic texts, or the like. Weights 170 contain information indicating input data set 130. According to an embodiment of the present disclosure, weights 170 may be used to retrain a new data model, which can be used for the same purpose as a training model of an original data set (i.e., generating task output 150), or can be used for other purposes, such as using all or part of the weights to reconstruct the original data set, or combining other data sets to generate a synthetic data set. As described above, the weights contain information (the most useful information) that indicates the original data set, and therefore, these weights can be used to reconstruct the original data set with an appropriate accuracy as needed. It should be understood that, in this case, the technical solution of the present disclosure can store the extracted weights with a small loss cost, instead of storing the original data set.

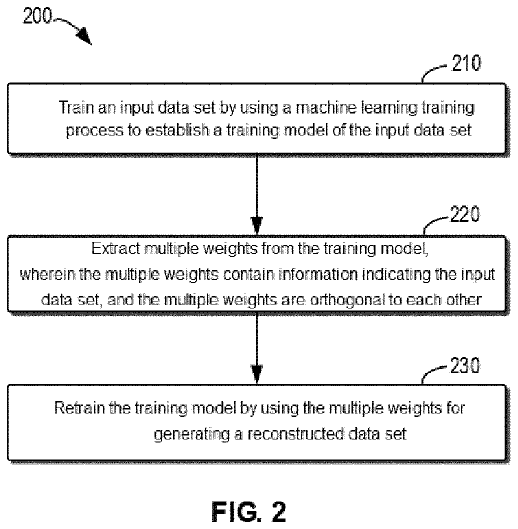

FIG. 2 is a flowchart of example method 200 for data distillation of a data storage system according to an embodiment of the present disclosure. For example, method 200 may be performed by computing device 110 as shown in FIG. 1. It should be understood that method 200 may also include additional actions not shown and/or may omit actions shown, and the scope of the present disclosure is not limited in this regard. The flowchart of FIG. 2 will be described below with reference to FIG. 1.

At block 210, an input data set (for example, input data set 130 in FIG. 1) is trained by using a machine learning training process to establish a training model of the input data set. It should be understood that the machine learning training process may include implementation of one or more machine learning algorithms.

A novel self-supervised data distillation algorithm is provided in the technical solution of the present disclosure. The above process of training the input data set by using the machine learning training process may be used as a specific implementation for realizing the self-supervised data distillation algorithm. The self-supervised data distillation algorithm mainly involves two tasks, namely, classification and feature extraction. An attention-based mechanism of the present disclosure is described below in combination with a logical regression algorithm and a support vector machine (SVM) algorithm.

In the logical regression algorithm, equation (1) provides a logical function

$$h ( w , x ) = \frac{1}{1 + exp ( - {w}^{T} x )} \qquad ( 1 )$$

Assuming that the range of a category label is [0, 1], without considering derivation, a loss function can be written as:

$$L ( w , x ) = {\sum }_{i = 1}^{N} {[ h ( w , {x}_{i} ) - {y}_{i} ]}^{2} \qquad ( 2 )$$

This can be regarded as a special case of the attention-based model with only one weight. In other words, the logical regression model is a single-weight attention model. Assuming that an optimal weight has been obtained and used as a unique data sample point:

xᵢ=wᵥ, i=1 (3)

And a data label corresponding to xᵢ is 1, so that a new set of data {xᵢ, 1} is obtained. Then, when the unique sample point is used to retrain the logical regression model and when the model converges, a new optimal weight w′ can be obtained, and apparently w′=w₀. Even if one synthetic sample point is used, it is consistent with a model obtained by using N sample points. It should be understood that because the weight of the logical regression model can be regarded as a projection, it projects original data in a more optimal direction; it can also be regarded as a data point, and data with a label 1 has the highest correlation.

In the support vector machine algorithm, it is assumed that the size of the data set is N, and the number of support vectors is M. For a trained SVM model, its output model when used for discrimination is:

$${y}_{i} = sgn [ {\sum }_{j = 1}^{N} {α}_{j} {y}_{j} Φ ( {x}_{j} , {X}_{i} ) ] \qquad ( 4 )$$

Where sgn[ ] is a symbolic function. In SVM, the most important data points are referred to as support vectors, and these vectors are also data in the original data set. At the same time, these support vectors may also be referred to as weights. The corresponding objective loss function in the SVM is:

$$L ( α ) = {\sum }_{i = 1}^{N} {\vert sgn [ {\sum }_{j = 1}^{N} {α}_{j} {y}_{j} Φ ( {x}_{j} , {x}_{i} ) ] - {y}_{i} \vert}^{2} + λ {\sum }_{i = 1}^{N} {α}_{i} \qquad ( 5 )$$

This is also consistent with the attention model. Assuming that the attention model has 4 weights w₁, w₂, w₃, w₄, the output model is:

$$\begin{matrix}{y}_{i} = sgn [ {\sum }_{k = 1}^{K} h ( {w}_{h} , {x}_{i} ) {β}_{b} ] \\ = {sgn [ [ h ( {w}_{1} , {x}_{i} ) h ( {w}_{2} , {x}_{i} ) h ( {w}_{3} , {x}_{i} ) h ( {w}_{4} , {x}_{i} ) ] [ \begin{matrix}1 \\ 1 \\ - 1 \\ - 1\end{matrix} ] ]}^{2}\end{matrix} \qquad ( 6 )$$

and a corresponding objective loss function in the SVM is:

$$L ( W ) = {\sum }_{i = 1}^{N} {[ sgn [ {\sum }_{k = 1}^{K} h ( {w}_{k} , {x}_{i} ) {β}_{k} ] - {y}_{i} ]}^{2} \qquad ( 7 )$$

Apparently, equation (5) and equation (7) have exactly the same representations, but different to-be-optimized parameters: the SVM needs to select support vectors, but the attention mechanism needs to optimize a weight matrix.

At block 220, multiple weights (for example, weights 170 in FIG. 1) are extracted from the training model, and the multiple weights contain information indicating an input data set (for example, input data set 130 in FIG. 1), and the multiple weights are orthogonal to each other. It should be understood that by making the multiple weights orthogonal to each other, the training model can make full use of correlation of the data itself, so that the training model is optimized.

At block 230, the training model is retrained by using the multiple weights for generating a reconstructed data set. It should be noted that the reconstructed data set here is different from task output 150 in FIG. 1 because the reconstructed data set is directly obtained by using the extracted multiple weights instead of task output 150 obtained through the above training process. Details of generating the reconstructed data set will be described in more detail below. It should be understood that the technical solution of the present disclosure has an improved model construction compared with existing data set distillation algorithms, so it is more effective and robust.

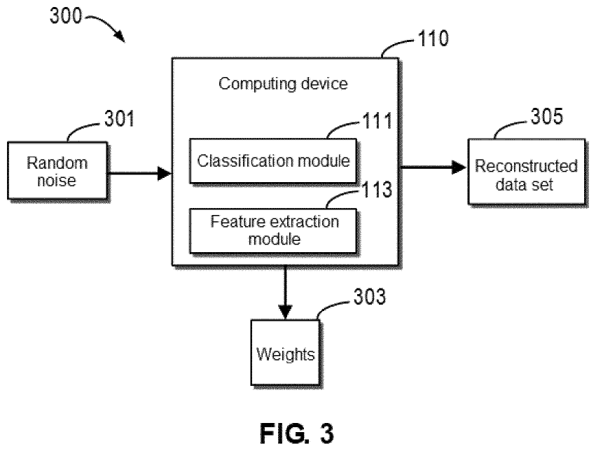

FIG. 3 is a schematic diagram of another example environment 300 in which an embodiment of the present disclosure can be implemented. As shown in FIG. 3, environment 300 includes computing device 110, random noise 301, weights 303, and reconstructed data set 305. It should be understood that the structure of environment 300 is described for illustrative purposes only, and does not imply any limitation to the scope of the present disclosure.

It should be noted that computing device 110 in FIG. 3 and the components such as classification module 111 and feature extraction module 113 therein correspond to the components in FIG. 1, and the description of functions thereof will not be repeated here. After computing device 110 receives random noise 301, weights 303 and reconstructed data set 305 can be obtained. It should be understood that after training input data set 130 in FIG. 1, feature extraction module 113 in computing device 110 has contained information required to extract weights 170. Therefore, after computing device 110 receives random noise 301, classification module 111 needs to be retrained, so that extracted weights 303 are consistent with weights 170 in FIG. 1. In this way, it can be ensured that reconstructed data set 305 retains the information indicating the original data set contained in the weights, so as to “restore” the data set to the greatest extent. It should be understood that if there is no random noise 301, it is relatively easy to derive the data set from weights 170 in FIG. 1, but in a possible case of partial data loss, it may become very difficult to reconstruct the data set. By introducing random noise 301, the technical solution of the present disclosure can still generate a reconstructed data set under extreme conditions such as partial data loss, thereby protecting the stored data to the greatest extent while maintaining robustness.

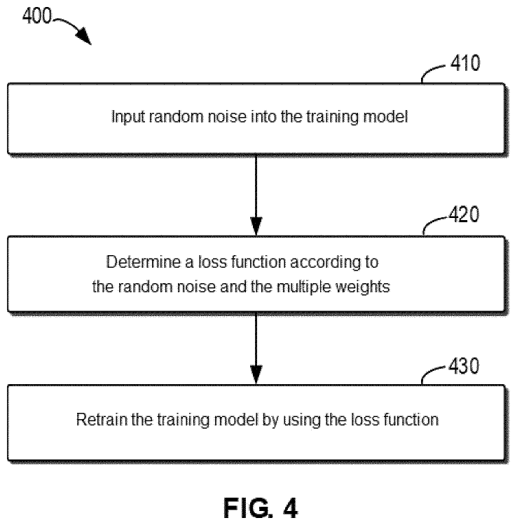

FIG. 4 is a flowchart of an example method for retraining the training model according to the extracted weights according to an embodiment of the present disclosure. For example, method 400 may be performed by computing device 110 as shown in FIG. 3. It should be understood that method 400 may further include additional actions not shown and/or may omit actions shown. The scope of the present disclosure is not limited in this aspect. The flowchart of FIG. 4 will be described below with reference to FIG. 1 and FIG. 3.

At block 410, random noise (e.g., random noise 301 in FIG. 3) is input into the training model. At block 420, a loss function is determined based on the random noise and the extracted multiple weights (e.g., weights 170 in FIG. 1). Then, at block 430, the loss function is used to retrain the training model. It should be noted that method 400 of FIG. 4 ensures that weights 303 extracted again are consistent with weights 170 extracted in FIG. 1, thereby ensuring that reconstructed data set 305 retains the information indicating the original data set contained in the weights. It should also be understood that for important data, the above process of retraining the data model can be repeated, and even sets of different weights and reconstructed data sets can be obtained according to different needs, and stored in a memory of the data storage system for later use.

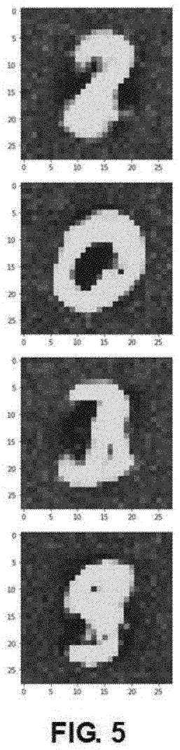

FIG. 5 is a schematic diagram of an example image generated by using the method of the present disclosure according to an embodiment of the present disclosure. By using the technical solution of the present disclosure, in the process of model training, the generated data set, such as distillation images, can be displayed. For example, in FIG. 5, images representing Arabic numerals “3,” “8,” and “0” are shown. The images representing the Arabic numerals “3” and “8” or their “weights” may also be combined to generate new images. For example, the fourth image in FIG. 5 shares the greatest similarity with the images representing the Arabic numerals “3” and “8” at the same time. As can be seen, the set of weights and reconstructed data set can be used not only to “restore” the original data set, but also for other tasks, such as synthesizing new images, forming new text, and so on.

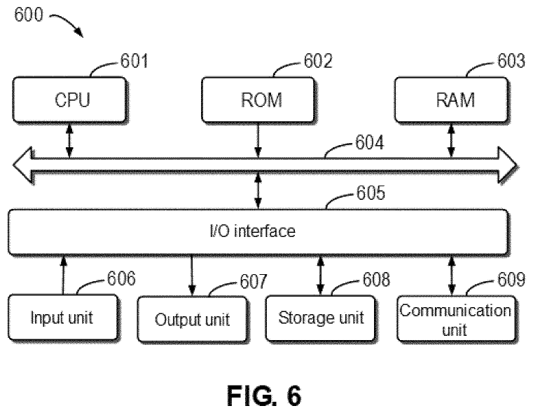

FIG. 6 is a schematic block diagram of example device 600 that can be used to implement an embodiments of the content of the present disclosure. For example, computing device 110 as shown in FIG. 1 may be implemented by electronic device 600. As shown in FIG. 6, device 600 includes central processing unit (CPU) 601 that may perform various appropriate actions and processing according to computer program instructions stored in read-only memory (ROM) 602 or computer program instructions loaded from storage unit 608 to random access memory (RAM) 603. Various programs and data required for the operation of device 600 may also be stored in RAM 603. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices over a computer network such as an Internet and/or various telecommunication networks.

The various processes and processing described above, for example, methods 200 and/or 400, may be performed by CPU 601. For example, in some embodiments, methods 200 and/or 400 may be implemented as a computer software program that is tangibly included in a machine-readable medium such as storage unit 608. In some embodiments, part or all of the computer program may be loaded and/or installed onto device 600 via ROM 602 and/or communication unit 609. When the computer program is loaded to RAM 603 and executed by CPU 601, one or more actions of methods 200 and/or 400 described above may be performed.

Illustrative embodiments of the present disclosure include a method, an electronic device, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device such as a punch card or a raised structure in a groove having instructions stored thereon, and any suitable combination thereof. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, state setting data, or source code or object code written in one programming language or any combination of several programming languages, including an object oriented programming language, such as Smalltalk and C++, and a conventional procedural programming language, such as the “C” language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer may be connected to a user computer through any kind of networks, including a local area network (LAN) or a wide area network (WAN), or can be connected to an external computer (for example, connected through the Internet using an Internet service provider). In some embodiments, an electronic circuit, for example, a programmable logic circuit, a field programmable gate array (FPGA), or a programmable logic array (PLA), is personalized by utilizing state information of the computer-readable program instructions, wherein the electronic circuit may execute computer-readable program instructions so as to implement various aspects of the present disclosure.

Various aspects of the present disclosure are described herein with reference to flowcharts and/or block diagrams of the method, the electronic device (system), and the computer program product according to embodiments of the present disclosure. It should be understood that each block in the flowcharts and/or block diagrams as well as a combination of blocks in the flowcharts and/or block diagrams may be implemented using computer-readable program instructions.

These computer-readable program instructions can be provided to a processing unit of a general-purpose computer, a special-purpose computer, or a further programmable data processing electronic device, thereby producing a machine, such that these instructions, when executed by the processing unit of the computer or the further programmable data processing electronic device, produce electronic devices for implementing functions/actions specified in one or more blocks in the flowcharts and/or block diagrams. These computer-readable program instructions may also be stored in a computer-readable storage medium, and these instructions cause a computer, a programmable data processing electronic device, and/or other devices to operate in a specific manner; and thus the computer-readable medium having instructions stored includes an article of manufacture that includes instructions that implement various aspects of the functions/actions specified in one or more blocks in the flowcharts and/or block diagrams.

The computer-readable program instructions may also be loaded to a computer, a further programmable data processing electronic device, or a further device, so that a series of operating steps may be performed on the computer, the further programmable data processing electronic device, or the further device to produce a computer-implemented process, such that the instructions executed on the computer, the further programmable data processing electronic device, or the further device may implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flowcharts as well as a combination of blocks in the block diagrams and/or flowcharts may be implemented using a special hardware-based system that executes specified functions or actions, or using a combination of special hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of the illustrated embodiments. The selection of terms as used herein is intended to best explain the principles and practical applications of the various embodiments or technical improvements to technologies on the market, and to otherwise enable persons of ordinary skill in the art to understand the embodiments disclosed here.

What is claimed is:

1. A method for data distillation, comprising:
training an input data set by using a machine learning training process to establish a training model of the input data set;
extracting multiple weights from the training model of the input data set, wherein the multiple weights contain information indicating the input data set, and the multiple weights are orthogonal to each other; and
retraining the training model by using the multiple weights for generating a reconstructed data set.

2. The method according to claim 1, wherein retraining the training model by using the multiple weights comprises:
inputting random noise into the training model;
determining a loss function according to the random noise and the multiple weights; and
retraining the training model by using the loss function.

3. The method according to claim 2, further comprising:
inputting additional random noise into the retrained training model; and
executing the retrained training model to generate the reconstructed data set.

4. The method according to claim 1, wherein training the input data set by using the machine learning training process comprises:
performing feature extraction on the input data set by using a feature extraction loss function; and
classifying the input data set after feature extraction by using a classification loss function.

5. The method according to claim 1, wherein the machine learning training process comprises a convolutional neural network process and a fully connected layer process, and the input data set indicates an image.

6. An electronic device, comprising:
at least one processing unit; and
at least one memory coupled to the at least one processing unit and storing instructions for execution by the at least one processing unit, wherein the instructions, when executed by the at least one processing unit, cause the electronic device to perform actions comprising:
training an input data set by using a machine learning training process to establish a training model of the input data set;
extracting multiple weights from the training model of the input data set, wherein the multiple weights contain information indicating the input data set, and the multiple weights are orthogonal to each other; and
retraining the training model by using the multiple weights, for generating a reconstructed data set.

7. The electronic device according to claim 6, wherein retraining the training model by using the multiple weights comprises:
inputting random noise into the training model;
determining a loss function according to the random noise and the multiple weights; and
retraining the training model by using the loss function.

8. The electronic device according to claim 7, wherein the actions further comprise:
inputting additional random noise into the retrained training model; and
executing the retrained training model to generate the reconstructed data set.

9. The electronic device according to claim 6, wherein training the input data set by using the machine learning training process comprises:
performing feature extraction on the input data set by using a feature extraction loss function; and
classifying the input data set after feature extraction by using a classification loss function.

10. The electronic device according to claim 6, wherein the machine learning training process comprises a convolutional neural network process and a fully connected layer process, and the input data set indicates an image.

11. A computer program product tangibly stored in a computer storage medium and comprising machine-executable instructions that, when executed by a device, cause the device to perform a method for data distillation, the method comprising:
training an input data set by using a machine learning training process to establish a training model of the input data set;
extracting multiple weights from the training model of the input data set, wherein the multiple weights contain information indicating the input data set, and the multiple weights are orthogonal to each other; and
retraining the training model by using the multiple weights for generating a reconstructed data set.

12. The computer program product according to claim 11, wherein retraining the training model by using the multiple weights comprises:
inputting random noise into the training model;
determining a loss function according to the random noise and the multiple weights; and
retraining the training model by using the loss function.

13. The computer program product according to claim 12, wherein the method further comprises:
inputting additional random noise into the retrained training model; and
executing the retrained training model to generate the reconstructed data set.

14. The computer program product according to claim 11, wherein training the input data set by using the machine learning training process comprises:
performing feature extraction on the input data set by using a feature extraction loss function; and
classifying the input data set after feature extraction by using a classification loss function.

15. The computer program product according to claim 11, wherein the machine learning training process comprises a convolutional neural network process and a fully connected layer process, and the input data set indicates an image.
